(19) United States
(12) Patent Application Publication
(10) Pub. No.: US 2007/0132699 A1
(43) Pub. Date: Jun. 14, 2007

(54) Output buffer for reducing EMI, source driver including the same, and display device including the same

(75) Inventor: Yang-Wook Kim, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/436,682

(22) Filed: May 18, 2006

(30) Foreign Application Priority Data
Dec. 8, 2005 (KR) 10-2005-0119405

(51) Int. Cl. G09G 3/36

(52) U.S. Cl. 345/100

(57) ABSTRACT

An output buffer for reducing electromagnetic interference (EMI) occurring due to a supply voltage applied to an integrated circuit includes a voltage sensing circuit sensing a voltage change caused by rapid voltage change at an output terminal in an internal circuit of the output buffer. The voltage sensing circuit senses a voltage change at the output terminal and applies a supply voltage or a ground voltage to the output terminal based on the sensing result, thereby gradually recovering the voltage of the output terminal to an original state. Accordingly, rapid current change does not occur at the output terminal of the output buffer, so that the voltage of the output terminal is maintained stable. As a result, EMI occurring due to the supply voltage is reduced.

### BACKGROUND OF THE INVENTION

This application claims the priority of Korean Patent Application No. 2005-0119405, filed on Dec. 8, 2005, in the Korean Intellectual Property Office, the disclosure of which is incorporated herein in its entirety by reference.

1. Technical Field

The present disclosure relates to a semiconductor apparatus, and more particularly, to an output buffer for reducing electromagnetic interference (EMI), and a source driver and a display device that include the same.

2. Discussion of the Related Art

FIG. 1 is a circuit diagram of a source driver 10 including a conventional output buffer. Referring to FIG. 1, the source driver 10 is a device generating liquid crystal driving voltages for driving source lines (or data lines) Y₁, Y₂, and Yₙ of a display panel (not shown), as is well known to those skilled in the art.

The source driver 10 includes a digital-to-analog converter (DAC) 20, a bias voltage generator 22, and a plurality of output buffers 30, 32, and 34. The DAC 20 generates analog voltages in response to a digital image signal output from a line latch (not shown). The bias voltage generator 22 applies a bias voltage to each of the output buffers 30 through 34. The output buffers 30 through 34 respectively control liquid crystal driving voltages respectively applied to the source lines (or data lines) Y₁, Y₂, and Yₙ. Each of the output buffers 30 through 34 may be implemented by a voltage follower or a unit gain buffer.

FIG. 2 illustrates an output buffer, such as 30, 32, or 34 as shown in FIG. 1, including an output driver and a compensation capacitor CC. FIG. 3 illustrates waveforms of output signals of the output buffer shown in FIG. 2. Referring to FIGS. 1 through 3, the compensation capacitor CC is connected between an output terminal OUT and a node N1 of the output driver implemented by a PMOS transistor MPOUT and a NMOS transistor MNOUT. VGP and VGN are implemented by modeling a predetermined bias voltage allowing the output driver to operate in class AB.

When a rapid voltage change, for example, a voltage drop or voltage rise, occurs at the output terminal OUT of the outputbuffer, a voltage V_{N1} of the node N1 also rapidly changes due to the compensation capacitor CC, which couples the output terminal OUT and the node N1. For example, when a rapid voltage drop occurs at the output terminal OUT of the output buffer, the voltage V_{N1} of the node N1 also drops rapidly. Accordingly, a voltage between a gate and a source of the PMOS transistor MPOUT decreases. Since the PMOS transistor MPOUT applies a voltage VDD of a power supply to the node N1, a voltage V_{OUT} of the output terminal OUT is quickly recovered to an original voltage. In this situation, abrupt current is supplied from the power supply to the node N1 and the output terminal OUT, and this abrupt current may cause EMI. The EMI may adversely affect the operation of a source driver or display device which includes the output driver.

### SUMMARY OF THE INVENTION

Embodiments of the present invention provide an output buffer for reducing electromagnetic interference (EMI), and a source driver and a display device which include the output buffer.

According to an embodiment of the present invention, there is provided an output buffer for controlling a liquid crystal driving voltage. The output buffer includes a voltage sensing circuit sensing a rapid change of voltage at an output terminal. The voltage sensing circuit senses a voltage change at the output terminal and applies a supply voltage or a ground voltage to the output terminal based on the sensing result, thereby gradually recovering the voltage of the output terminal to an original state. Accordingly, rapid current change does not occur at the output terminal of the output buffer and, therefore, EMI occurring due to the supply voltage is reduced.

According to an embodiment of the present invention, there is provided an output buffer including a first transistor connected between a first terminal receiving a supply voltage and an output terminal; a second transistor connected between a second terminal receiving a ground voltage and the output terminal; a first capacitor connected between a first node receiving a first signal and the output terminal; a second capacitor connected between a second node receiving a second signal and the output terminal; a bias voltage generator generating a first bias voltage applied to a gate of the first transistor and a second bias voltage applied to a gate of the second transistor; a first voltage sensing circuit connected between the first terminal and the first node to sense a change in a voltage level of the first node and apply the supply voltage to the first node based on a sensing result; and a second voltage sensing circuit connected between the second terminal and the second node to sense a change in a voltage level of the second node and apply the ground voltage to the second node based on a sensing result.

The first voltage sensing circuit may be a PMOS transistor having a gate and a drain connected to the first node in common, and the second voltage sensing circuit may be a NMOS transistor having a gate and a drain connected to the second node in common.

According to an embodiment of the present invention, there is provided an output buffer including an NMOS input folded cascode operational amplifier comprising a first input terminal, a second input terminal, and a first node to output to the first node a first signal having a voltage level proportional to a difference between a voltage level of a first differential input signal input to the first input terminal and a voltage level of a second differential input signal input to the second input terminal; a PMOS input folded cascode operational amplifier comprising a second node to output to the second node a second signal having a voltage level proportional to the difference between the voltage level of the first differential input signal and the voltage level of the second differential input signal; a PMOS transistor connected between a supply terminal receiving a supply voltage and an output terminal of the output buffer; an NMOS transistor connected between a ground terminal receiving a ground voltage and the output terminal; a first capacitor connected between the first node and the output terminal; a second capacitor connected between the second node and the output terminal; a first bias voltage generator generating a first bias voltage applied to a gate of the PMOS transistor and a second bias voltage applied to a gate of the NMOS transistor; a first voltage sensing circuit connected between the supply terminal and the first node to sense a change in a voltage level of the first node and apply the supply voltage to the first node based on a result of the sensing; and a second voltage sensing circuit connected between the second terminal and the ground node to sense a change in a voltage level of the second node and apply the ground voltage to the second node based on a result of the sensing.

The first voltage sensing circuit may be a PMOS transistor having a gate and a drain which are connected to the first node in common, and the second voltage sensing circuit may be an NMOS transistor having a gate and a drain which are connected to the second node in common.

According to an embodiment of the present invention, there is provided a source driver including a digital-to-analog converter generating analog voltages in response to digital image data; and a plurality of output buffers each connected to a voltage follower, each output buffer receiving and buffering a corresponding analog voltage among the analog voltages output from the digital-to-analog converter and outputting a buffered signal to a corresponding data line among a plurality of data lines.

According to an embodiment of the present invention, there is provided a display device including a display panel comprising a plurality of data lines and a plurality of gate lines; and a source driver driving the plurality of data lines. The source driver includes a digital-to-analog converter generating analog voltages in response to digital image data; and a plurality of output buffers each connected to a voltage follower, each output buffer receiving and buffering a corresponding analog voltage among the analog voltages output from the digital-to-analog converter and outputting a buffered signal to a corresponding data line among the plurality of data lines.

### BRIEF DESCRIPTION OF THE DRAWINGS

Exemplary embodiments of the present invention can be understood in more detail from the following descriptions taken in conjunction with the attached drawings in which:

FIG. 1 is a circuit diagram of a source driver including a conventional output buffer;

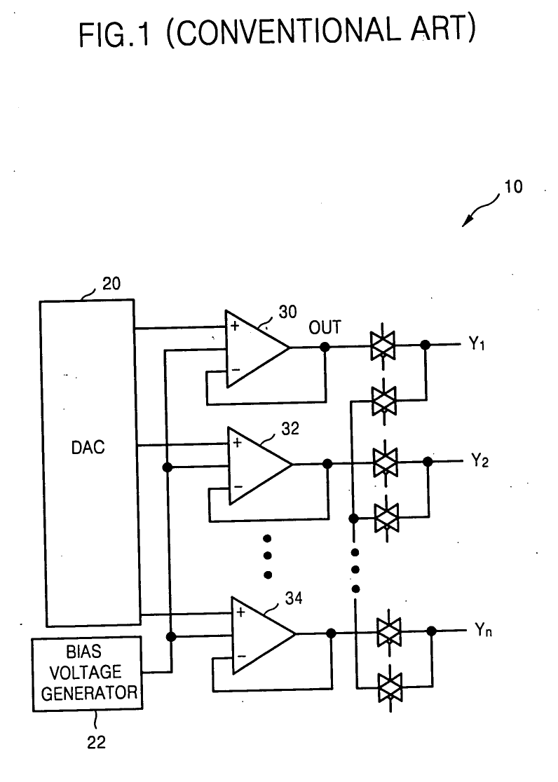

FIG. 2 illustrates an output buffer shown in FIG. 1 including an output driver and a compensation capacitor;

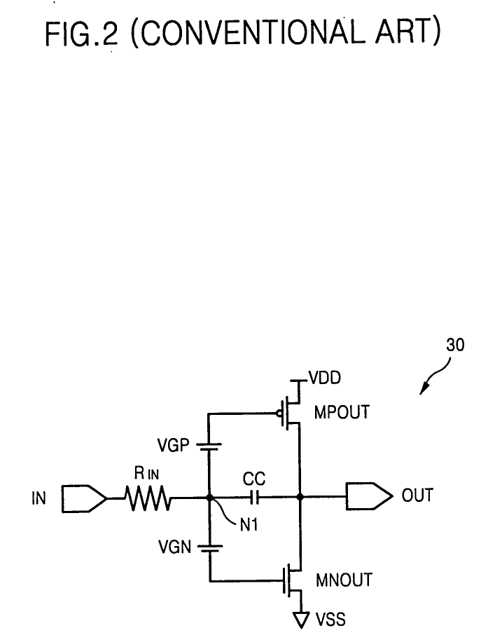

FIG. 3 illustrates waveforms of output signals of the output driver shown in FIG. 2;

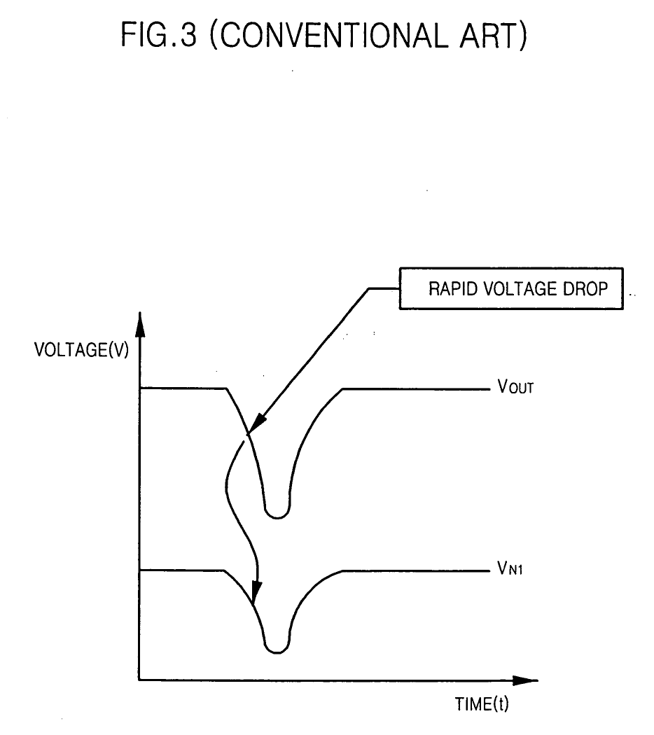

FIG. 4 is a circuit diagram of an output driver for reducing electromagnetic interference (EMI), according to an embodiment of the present invention;

FIG. 5 is a circuit diagram of an output buffer according to an embodiment of the present invention;

FIG. 6 illustrates waveforms of output signals of an output driver that does not include voltage sensing circuits according to an embodiment of the present invention;

FIG. 7 illustrates waveforms of output signals of an output driver that includes voltage sensing circuits according to an embodiment of the present invention; and

FIG. 8 is a block diagram of a display device including an output buffer according to an embodiment of the present invention.

### DESCRIPTION OF THE EXEMPLARY EMBODIMENTS

Exemplary embodiments of the present invention are described more fully hereinafter with reference to the attached drawings. Like reference numerals in the drawings denote like elements.

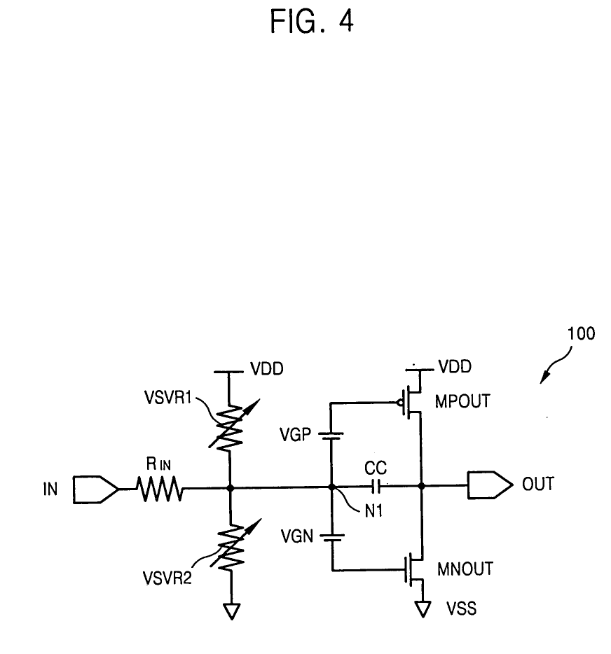

FIG. 4 is a circuit diagram for explaining a scheme of sensing an output voltage of an output driver 100 and compensating the output voltage to reduce electromagnetic interference (EMI), according to an embodiment of the present invention. Referring to FIG. 4, a compensation capacitor CC is connected between an output terminal OUT and a node N1 of the output driver 100 of an output buffer that includes a PMOS transistor MPOUT and an NMOS transistor MNOUT. Voltage sources VGP and VGN are implemented by modeling a predetermined bias voltage allowing the output driver to operate in class AB.

A first voltage sensing variable resistor VSVR1 is connected between a first terminal receiving a supply voltage VDD from a power supply and the node N1. When an output voltage level of the output terminal OUT of the output driver 100 rapidly decreases due to an external environment, for example, when the output buffer drives data lines after performing charge sharing, a voltage level of the node N1 also rapidly decreases due to the compensation capacitor CC connected between the output terminal OUT and the node N1. Here, the first voltage sensing variable resistor VSVR1 decreases its resistance based on the voltage level of the node N1 when the supply voltage VDD is applied to the node N1 so that the voltage level of the node N1 is maintained stable. Accordingly, since rapid change of the voltage level of the node N1 is reduced, the output voltage level of the output terminal OUT of the output driver 100 gradually recovers to the original voltage level. As a result, a rapid current change does not occur at the output terminal OUT of the output driver 100 and, therefore, EMI is reduced.

A second voltage sensing variable resistor VSVR2 is connected between the node N1 and a second terminal connected to a ground VSS. When the output voltage level of the output terminal OUT of the output driver 100 rapidly increases due to an external environment, for example, when the output buffer drives data lines after performing charge sharing, the voltage level of the node N1 also rapidly increases. Here, the second voltage sensing variable resistor VSVR2 increases its resistance based on the voltage level of the node N1 when the node N1 is connected to the ground VSS so that the voltage level of the node N1 is maintained stable. Accordingly, since a rapid change of the voltage level of the node N1 is reduced, the output voltage level of the output terminal OUT of the output driver 100 gradually recovers to the original voltage level. As a result, a rapid current change does not occur at the output terminal OUT of the output driver 100 and, therefore, EMI is reduced.

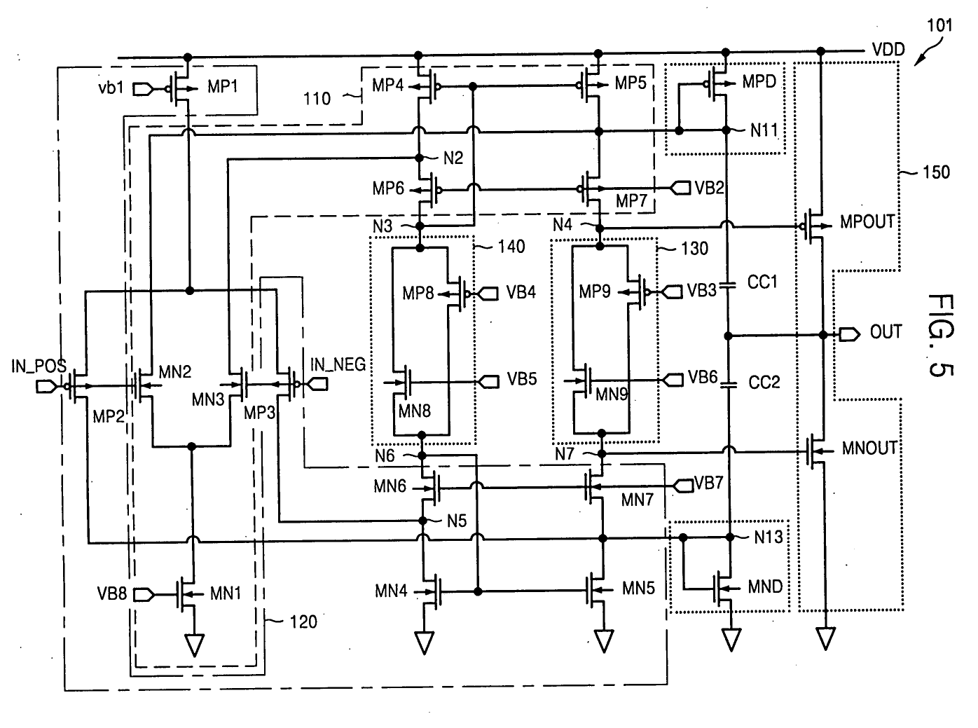

FIG. 5 is a circuit diagram of an output buffer 101 according to an embodiment of the present invention. Referring to FIG. 5, the output buffer 101 includes an NMOS input folded cascode operational amplifier 110, a PMOS input folded cascode operational amplifier 120, a first bias voltage generator 130, a second bias voltage generator 140, a first voltage sensing circuit MPD, a second voltage sensing circuit MND, a first capacitor CC1, a second capacitor CC2, and an output driver 150. In this embodiment of the present invention, the output buffer 101 may be implemented by a cascode class-AB CMOS amplifier.

The NMOS input folded cascode operational amplifier 110 includes a first input terminal, that is, a gate of an NMOS transistor MN2, a second input terminal, that is, a gate of an NMOS transistor MN3, and a first node N11. The NMOS input folded cascode operational amplifier 110 outputs to the first node N11 a first signal having a voltage level proportional to a difference between a voltage level of a first differential input signal IN_POS input to the first input terminal and a voltage level of a second differential input signal IN_NEG input to the second input terminal. When the output buffer 101 is implemented by a unit gain buffer, the first differential input signal IN-POS corresponds to an output signal of a digital-to-analog converter (DAC) and the second differential input signal IN_NEG corresponds to an output signal of the output buffer 101.

The PMOS input folded cascode operational amplifier 120 includes a second node N13 and outputs to the second node N13 a second signal having a voltage level proportional to the difference between the voltage level of the first differential input signal IN_POS input to a first input terminal, that is, a gate of a PMOS transistor MP2 and the voltage level of the second differential input signal IN_NEG input to a second input terminal, that is a gate of a PMOS transistor MP3.

The output driver 150 includes a PMOS transistor MPOUT and an NMOS transistor MNOUT. The output driver 150 may be an output driver of a push-pull CMOS amplifier. The PMOS transistor MPOUT is connected between a first terminal receiving a supply voltage VDD of a power supply and an output terminal OUT of the output buffer 101. The NMOS transistor MNOUT is connected between a second terminal receiving the ground voltage VSS and the output terminal OUT.

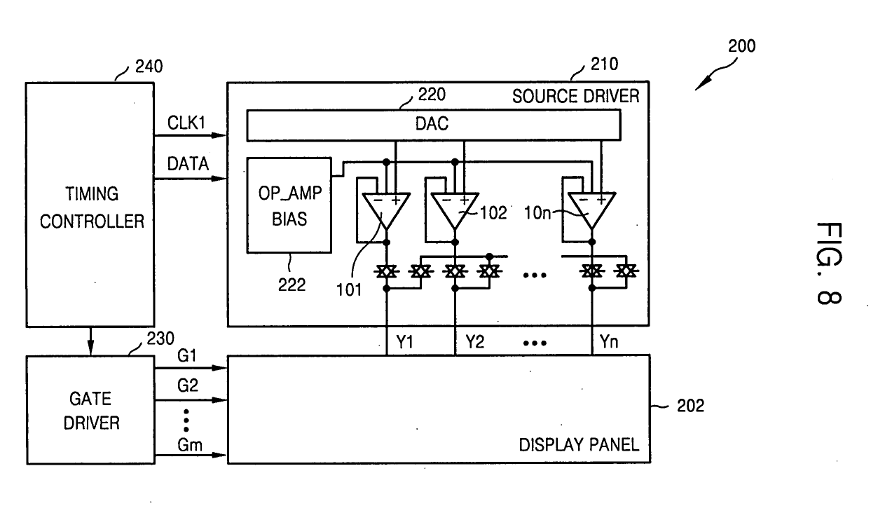

The first bias voltage generator 130 includes a PMOS transistor MP9 and an NMOS transistor MN9 which are connected in parallel between a node N4 and a node N7. In response to bias voltages VB3 and VB6 output from a bias voltage generator 222 shown in FIG. 8, the first bias voltage generator 130 generates a first bias voltage applied to a gate of the PMOS transistor MPOUT and a second bias voltage applied to a gate of the NMOS transistor MNOUT. Here, the PMOS transistor MP9 and the NMOS transistor MN9 respectively provides biases so that the PMOS transistor MPOUT and the NMOS transistor MNOUT can operate in class AB.

The second bias voltage generator 140 includes a PMOS transistor MP8 and an NMOS transistor MN8 which are connected in parallel between a node N3 and a node N6. The PMOS transistor MP8 applies a predetermined bias voltage to PMOS transistors MP4 and MP5 in response to a bias voltage VB4 output from the bias voltage generator 222 shown in FIG. 8. In other words, the PMOS transistor MP8 controls the bias of the PMOS transistors MP4 and MP5. The NMOS transistor MN8 applies a predetermined bias voltage to NMOS transistors MN4 and MN5 in response to a bias voltage VB5 output from the bias voltage generator 222 shown in FIG. 8. In other words, the NMOS transistor MN8 controls the bias of the NMOS transistors MN4 and MN5.

The first voltage sensing circuit MPD is connected between the power supply and the first node N11. The first voltage sensing circuit MPD senses a change in a voltage of the first node N11 and applies the supply voltage VDD to the first node N11 based on the sensing result. The first voltage sensing circuit MPD may be implemented by a PMOS transistor having a gate and a drain which are both connected to the first node N11, i.e., a diode-connected PMOS transistor, but the embodiments of the present invention is not restricted thereto.

The second voltage sensing circuit MND is connected between ground and the second node N13. The second voltage sensing circuit MND senses a change in a voltage level of the second node N13 and applies the ground voltage VSS to the second node N13 based on the sensing result. The second voltage sensing circuit MND may be implemented by an NMOS transistor having a gate and a drain which are both connected to the second node N13, i.e., a diode-connected NMOS transistor, but the embodiment of the present invention is not restricted thereto.

The first capacitor CC1 is connected between the first node N11 and the output terminal OUT. The second capacitor CC2 is connected between the second node N13 and the output terminal OUT. The capacitors CC1 and CC2 are provided for stable operation.

When the first voltage sensing circuit MPD is implemented by a diode-connected PMOS transistor, the PMOS transistor MPD is maintained at an off-state in a normal state. In addition, the voltage of the first node N11 is maintained at a very low voltage, for example, a voltage lower than a threshold voltage of the PMOS transistor MPD in the normal state.

However, when the voltage level of the output terminal OUT decreases rapidly, since the rapid decrease of the voltage level is transmitted to the first node N11 via the first capacitor CC1, the PMOS transistor MPD is turned on based on the voltage level of the first node N11. Accordingly, the supply voltage VDD is applied to the first node N11, thereby recovering the voltage level of the first node N11 and/or the voltage level of the output terminal OUT to a normal-state voltage.

Thus, the first voltage sensing circuit MPD prevents rapid change of voltage (or current) at the first node N11 and/or the output terminal OUT. As a result, EMI occurring in the output buffer 101 is reduced. In other words, since rapid current flow does not occur in the output terminal OUT, EMI occurring in the output buffer 101 according to an embodiment of the present invention is remarkably reduced as compared to EMI occurring in conventional output buffers.

When the second voltage sensing circuit MND is implemented by a diode-connected NMOS transistor, the NMOS transistor MND is maintained at the off-state in the normal state. In addition, the voltage of the second node N13 is maintained at a very low voltage, for example, a voltage lower than a threshold voltage of the NMOS transistor MND in the normal state.

However, when the voltage level of the output terminal OUT increases rapidly, since the rapid increase of the voltage level is transmitted to the second node N13 via the second capacitor CC2, the NMOS transistor MND is turned on based on the voltage level of the second node N13. Accordingly, increased current of the second node N13 flows to a ground, thereby recovering the voltage level of the second node N13 and/or the voltage level of the output terminal OUT to a normal-state voltage.

Thus, the second voltage sensing circuit MND prevents rapid change of voltage (or current) at the second node N13 and/or the output terminal OUT. As a result, EMI occurring in the output buffer 101 is reduced.

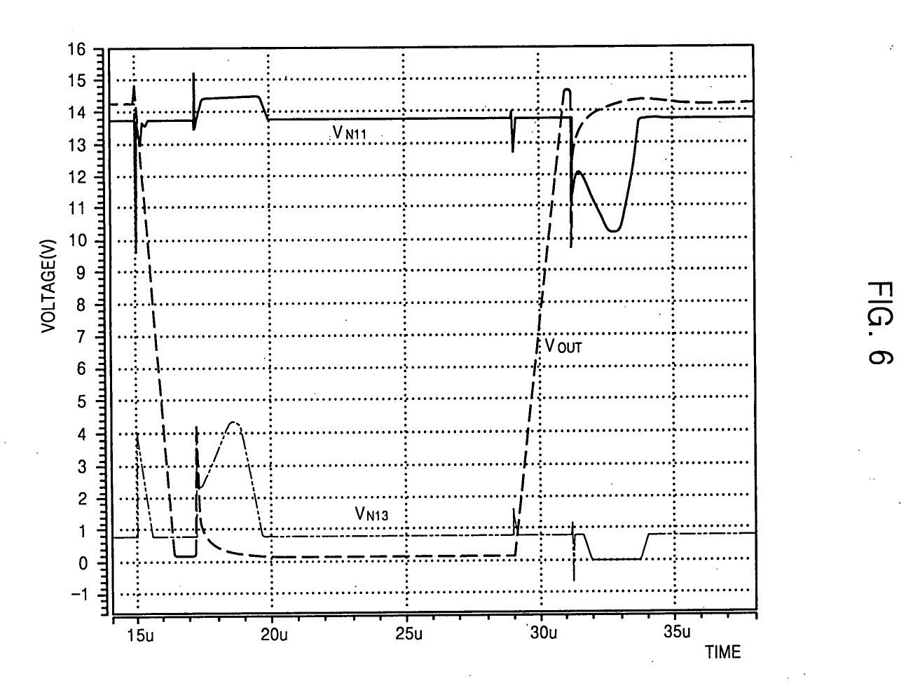

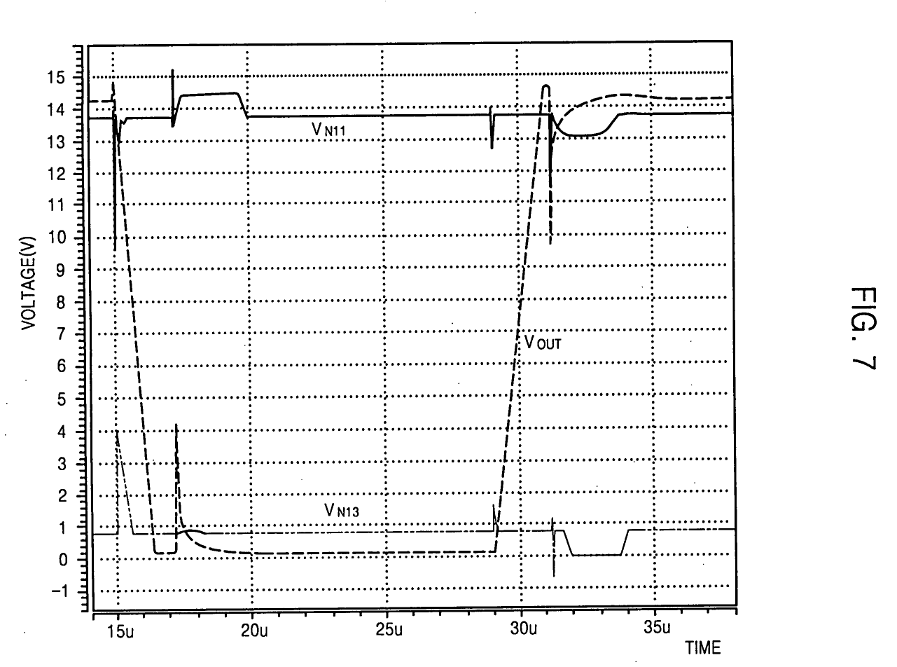

FIG. 6 illustrates waveforms of output signals of an output driver that does not include voltage sensing circuits. FIG. 7 illustrates waveforms of output signals of an output driver that includes voltage sensing circuits according to an embodiment of the present invention.

Referring to FIGS. 6 and 7, it can be seen that changes in voltages VN11 and VN13 at the nodes of the output driver including the voltage sensing circuits (MPD and MND) according to an embodiment of the present invention are remarkably reduced as compared to changes in the voltages VN11 and VN13 at the nodes of the output driver that does not include the voltage sensing circuits (MPD and MND). Accordingly, since rapid current change does not occur in the output driver including the voltage sensing circuits (MPD and MND) according to an embodiment of the present invention, EMI is remarkably reduced in the output driver.

FIG. 8 is a block diagram of a display device 200 including an output buffer according to an embodiment of the present invention. The display device 200 includes a display panel 202, a source driver 210, a gate driver 230, and a timing controller 240. The display device 200 may be implemented by a flat panel display (FPD) such as a liquid crystal display (LCD), an organic light-emitting diode (OLED), or a plasma display panel (PDP).

As is well known in the art, the display panel 202 is a device for displaying an image and includes a plurality of source lines (or data lines) Y1 through Yn (where “n” is a natural number), a plurality of gate lines (or scan lines) G1 through Gm (where “m” is a natural number), and a plurality of pixel electrodes (not shown). The source driver 210 includes a DAC 220, a bias voltage generator 222 generating a plurality of bias voltages (VB1 through VB8 shown in FIG. 5), and a plurality of output buffers 101 through 10n (where “n” is a natural number).

The DAC 220 generates analog voltages in response to a digital image signal output from a line latch (not shown).

The output buffers 101 through 10n, respectively, control liquid crystal driving voltages respectively applied to the. corresponding source lines Y1 through Yn. Each of the output buffers 101 through 10n may be implemented by a voltage follower or a unit gain buffer. As has been described with reference to FIGS. 4 through 7, each of the output buffers 101 through 10n senses a change in a voltage level of an output terminal and gradually recovers the voltage level of the output terminal. Accordingly, rapid current change does not occur in the output buffers 101 through 10n.

The gate driver 230 sequentially drives the gate lines G1 through Gm of the display panel 202.

The timing controller 240 controls operations of the source driver 210 and the gate driver 230 according to content set by a host computer, such as a central processing unit (CPU). For example, the timing controller 240 outputs digital image data DATA and a clock signal CLK1 used to display the digital image data DATA on the display panel 202 to the source driver 210.

As described above, according to an embodiment of the present invention, an output buffer senses rapid voltage change, which occurs at an output terminal due to an external environment, and recovers the voltage of the output terminal to a normal state based on the sensing result, so that rapid current change occurring at the output buffer can be reduced. In addition, since the output voltage of the output terminal is gradually recovered, rapid current change, i.e., surge peak current, does not occur in the output buffer. Accordingly, EMI due to current is reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An output buffer for controlling a liquid crystal driving voltage, the output buffer comprising:
a first transistor connected between a first terminal receiving a supply voltage and an output terminal of the output buffer;
a second transistor connected between a second terminal receiving a ground voltage and the output terminal of the output buffer;
a first capacitor connected between a first node receiving a first signal and the output terminal;
a second capacitor connected between a second node receiving a second signal and the output terminal;
a bias voltage generator generating a first bias voltage applied to a gate of the first transistor and a second bias voltage applied to a gate of the second transistor;
a first voltage sensing circuit connected between the first terminal and the first node to sense a change in a voltage level of the first node and apply the supply voltage to the first node based on a result of the sensing; and
a second voltage sensing circuit connected between the second terminal and the second node to sense a change in a voltage level of the second node and apply the ground voltage to the second node based on a result of the sensing.

2. The output buffer of claim 1, wherein the first voltage sensing circuit comprises a PMOS transistor having a gate and a drain connected to the first node in common, and the second voltage sensing circuit comprises an NMOS transistor having a gate and a drain connected to the second node in common.

3. The output buffer of claim 1, wherein the output buffer is formed as a class-AB complementary CMOS amplifier.

4. The output buffer of claim 1, wherein the output buffer is formed as a voltage follower.

5. An output buffer comprising:
an NMOS input folded cascode operational amplifier including a first input terminal, a second input terminal, and a first node to output to the first node a first signal having a voltage level proportional to a difference between a voltage level of a first differential input signal input to the first input terminal and a voltage level of a second differential input signal input to the second input terminal;
a PMOS input folded cascode operational amplifier including a second node to output to the second node a second signal having a voltage level proportional to the difference between the voltage level of the first differential input signal and the voltage level of the second differential input signal;
a PMOS transistor connected between a first terminal receiving a supply voltage and an output terminal of the output buffer;
an NMOS transistor connected between a second terminal receiving a ground voltage and the output terminal of the output buffer;
a first capacitor connected between the first node and the output terminal;
a second capacitor connected between the second node and the output terminal;
a first bias voltage generator generating a first bias voltage applied to a gate of the PMOS transistor and a second bias voltage applied to a gate of the NMOS transistor;
a first voltage sensing circuit connected between the first terminal and the first node to sense a change in a voltage level of the first node and apply the supply voltage to the first node based on a result of the sensing; and
a second voltage sensing circuit connected between the second terminal and the second node to sense a change in a voltage level of the second node and apply the ground voltage to the second node based on a result of the sensing.

6. The output buffer of claim 5, wherein the first voltage sensing circuit comprises a PMOS transistor having a gate and a drain connected to the first node in common, and the second voltage sensing circuit comprises an NMOS transistor having a gate and a drain connected to the second node in common.

7. The output buffer of claim 5, further comprising a second bias voltage generator generating a third bias voltage applied to the NMOS input folded cascode operational amplifier and a fourth bias voltage applied to the PMOS input folded cascode operational amplifier.

8. A source driver comprising:
a digital-to-analog converter generating analog voltages in response to digital image data; and
a plurality of output buffers each connected to a voltage follower, each output buffer receiving and buffering a corresponding analog voltage among the analog voltages output from the digital-to-analog converter and outputting a buffered signal to a corresponding data line among a plurality of data lines, wherein each output buffer comprises:
a PMOS transistor connected between a first terminal receiving a supply voltage and an output terminal of the output buffer;
an NMOS transistor connected between a second terminal receiving a ground voltage and the output terminal;
a first capacitor connected between a first node receiving a first signal generated based on the corresponding analog voltage and the output terminal;
a second capacitor connected between a second node receiving a second signal generated based on a signal output from the output terminal and the output terminal;
a bias voltage generator generating a first bias voltage applied to a gate of the PMOS transistor and a second bias voltage applied to a gate of the NMOS transistor;
a first voltage sensing circuit connected between the first terminal and the first node to sense a change in a voltage level of the first node and apply the supply voltage to the first node based on a result of the sensing; and
a second voltage sensing circuit connected between the second terminal is and the second node to sense a change in a voltage level of the second node and apply the ground voltage to the second node based on a result of the sensing.

9. The source driver of claim 8, wherein the first voltage sensing circuit comprises a PMOS transistor having a gate and a drain connected to the first node in common, and the second voltage sensing circuit comprising an NMOS transistor having a gate and a drain connected to the second node in common.

10. A source driver comprising:
a digital-to-analog converter generating analog voltages in response to digital image data; and
a plurality of output buffers each connected to a voltage follower, each output buffer receiving and buffering a corresponding analog voltage among the analog voltages output from the digital-to-analog converter and outputting a buffered signal to a corresponding data line, wherein each output buffer comprises:
an NMOS input folded cascode operational amplifier including a first input terminal, a second input terminal, and a first node to output to the first node a first signal having a voltage level proportional to a difference between a voltage level of a first differential input signal input to the first input terminal and a voltage level of a second differential input signal input to the second input terminal;
a PMOS input folded cascode operational amplifier including a second node to output to the second node a second signal having a voltage level proportional to the difference between the voltage level of the first differential input signal and the voltage level of the second differential input signal;
a PMOS transistor connected between a first terminal receiving a supply voltage and an output terminal of the buffer;
an NMOS transistor connected between a second terminal receiving a ground voltage and the output terminal of the buffer;
a first capacitor connected between the first node and the output terminal;
a second capacitor connected between the second node and the output terminal;
a bias voltage generator generating a first bias voltage applied to a gate of the PMOS transistor and a second bias voltage applied to a gate of the NMOS transistor;
a first voltage sensing circuit connected between the first terminal and the first node to sense a change in a voltage level of the first node and apply the supply voltage to the first node based on a result of the sensing; and
a second voltage sensing circuit connected between the second terminal and the second node to sense a change in a voltage level of the second node and apply the ground voltage to the second node based on a result of the sensing.

11. The source driver of claim 10, wherein the first voltage sensing circuit comprises a PMOS transistor having a gate and a drain connected to the first node in common, and the second voltage sensing circuit comprises an NMOS transistor having a gate and a drain connected to the second node in common.

12. A display device comprising:
a display panel comprising a plurality of data lines and a plurality of gate lines; and
a source driver driving the plurality of data lines,
wherein the source driver comprises:
a digital-to-analog converter generating analog voltages in response to digital image data; and
a plurality of output buffers each connected to a voltage follower, each output buffer receiving and buffering a corresponding analog voltage among the analog voltages output from the digital-to-analog converter and outputting a buffered signal to a corresponding data line among the plurality of data lines, and wherein
each output buffer comprises:
a PMOS transistor connected between a first terminal receiving a supply voltage and an output terminal of the buffer;
an NMOS transistor connected between a second terminal receiving a ground voltage and the output terminal;
a first capacitor connected between a first node receiving a first signal generated based on the corresponding analog voltage, which is input to a first input terminal, and the output terminal;
a second capacitor connected between a second node receiving a second signal generated based on a signal, which is output from the output terminal and then input to a second input terminal, and the output terminal;
a bias voltage generator generating a first bias voltage applied to a gate of the PMOS transistor and a second bias voltage applied to a gate of the NMOS transistor;
a first voltage sensing circuit connected between the first terminal and the first node to sense a change in a voltage level of the first node and apply the supply voltage to the first node based on a result of the sensing; and
a second voltage sensing circuit connected between the second terminal and the second node to sense a change in a voltage level of the second node and apply the ground voltage to the second node based on a result of the sensing.

13. The display device of claim 12, wherein the first voltage sensing circuit comprises a PMOS transistor having a gate and a drain connected to the first node in common, and the second voltage sensing circuit comprising an NMOS transistor having a gate and a drain connected to the second node in common.

14. A display device comprising:
a display panel comprising a plurality of data lines and a plurality of gate lines; and
a source driver driving the plurality of data lines,
wherein the source driver comprises:
a digital-to-analog converter generating analog voltages in response to digital image data; and
a plurality of output buffers each connected to a voltage follower, each output buffer receiving and buffering a corresponding analog voltage among the analog voltages output from the digital-to-analog converter and outputting a buffered signal to a corresponding data line among the plurality of data lines, and wherein
each output buffer comprises:
an NMOS input folded cascode operational amplifier including a first input terminal, a second input terminal, and a first node to output to the first node a first signal having a voltage level proportional to a difference between a voltage level of a first differential input signal input to the first input terminal and a voltage level of a second differential input signal input to the second input terminal;
a PMOS input folded cascode operational amplifier including a second node to output to the second node a second signal having a voltage level proportional to the difference between the voltage level of the first differential input signal and the voltage level of the second differential input signal;
a PMOS transistor connected between a first terminal receiving a supply voltage and an output terminal of the output buffer;
an NMOS transistor connected between a second terminal receiving a ground voltage and the output terminal of the output buffer;
a first capacitor connected between the first node and the output terminal of the output buffer;
a second capacitor connected between the second node and the output terminal of the output buffer;
a bias voltage generator generating a first bias voltage applied to a gate of the PMOS transistor and a second bias voltage applied to a gate of the NMOS transistor;
a first voltage sensing circuit connected between the first terminal and the first node to sense a change in a voltage level of the first node and apply the supply voltage to the first node based on a result of the sensing; and
a second voltage sensing circuit connected between the second terminal and the second node to sense a change in a voltage level of the second node and apply the ground voltage to the second node based on a result of the sensing.

15. The display device of claim 14, wherein the first voltage sensing circuit comprises a PMOS transistor having a gate and a drain connected to the first node in common, and the second voltage sensing circuit comprises an NMOS transistor having a gate and a drain connected to the second node in common.
